(19) United States
(12) Patent Application Publication
(10) Pub. No.: US 2013/0090828 A1
(43) Pub. Date: Apr. 11, 2013

(54) METHOD FOR STABILIZING A TWO-WHEELED VEHICLE HAVING A LATERALLY SLIPPING REAR WHEEL

(71) Applicant: Markus Lemejda, Ludwigsburg (DE)

(72) Inventor: Markus Lemejda, Ludwigsburg (DE)

(21) Appl. No.: 13/640,805

(22) PCT Filed: Feb. 15, 2011
(86) PCT No.: PCT/EP2011/052180

§ 371 Date: Dec. 21, 2012

(30) Foreign Application Priority Data
Apr. 14, 2010 (DE) 10 2010 003 951.9

(51) Int. Cl. B60T 8/1755

(52) U.S. Cl. CPC B60T 8/17552
USPC 701/83; 701/90

(57) ABSTRACT

In a method for stabilizing a two-wheeled vehicle in driving situations in which the two-wheeled vehicle oversteers, a variable describing the oversteering of the two-wheeled vehicle is ascertained and, if the variable exceeds a predefined threshold value, a control is carried out, a steering torque being applied to the steering of the two-wheeled vehicle and/or the brake pressure which acts on the front wheel brake being reduced or increased and/or the driving torque on the rear wheel being reduced or increased and/or the brake pressure on the rear wheel being increased or reduced.

### BACKGROUND OF THE INVENTION

1. Field of the Invention

The present invention relates to a method for stabilizing a two-wheeled vehicle, in particular a motorcycle, in driving situations in which the two-wheeled vehicle oversteers.

2. Description of the Related Art

When negotiating curves with a two-wheeled vehicle, it may occur that the rear wheel slips laterally in the curve. The two-wheeled vehicle then oversteers and no longer follows the path of motion desired by the driver. In addition, the centrifugal force is reduced, and the two-wheeled vehicle tips to the inside of the curve. Thus, driving situations of this type often result in overturning. The cause for such an oversteering may include, for example, excessive speed in the curve, excessive propulsive force, excessive braking torque or drag torque on the rear wheel or an excessively low friction coefficient of the roadway. For an oversteering two-wheeled vehicle, there is also the risk in particular of a rollover to the outside of the curve (highsider) if the friction coefficient of the roadway increases again. This may result in particularly serious accidents.

Modern automobiles are stabilized in such driving situations with the aid of a vehicle dynamics control system (electronic stability program, ESP). Such a vehicle dynamics control system is not yet available for two-wheeled vehicles.

### BRIEF SUMMARY OF THE INVENTION

It is therefore the object of the present invention to provide a method with the aid of which the lateral slip of the rear wheel of a two-wheeled vehicle may be recognized and the two-wheeled vehicle may be stabilized again.

According to the present invention it is proposed that a variable describing the oversteering of the two-wheeled vehicle, in particular the float angle or the change in the float angle, be ascertained during the driving operation of the vehicle and a vehicle dynamics control action be carried out if the float angle or the change in the float angle exceeds a predefined threshold value. Instead of the float angle, the slip angle of the rear wheel or a change in the slip angle may also be used, for example. At least one of the following measures may be used as a stabilizing intervention:
1. Applying a steering torque to the steering of the two-wheeled vehicle toward the inside of the curve: Due to the special driving physics of a single-track vehicle, a larger curve radius is produced, whereby ultimately the necessary lateral guiding force of the rear wheel is reduced. The steering torque may be generated, for example, via a steering torque final controlling element and/or indirectly by increasing the braking force on the front wheel.
2. Reducing the longitudinal force on the rear wheel to improve its ability to absorb the lateral guiding force: In the event of excessive propulsive force on the rear wheel, the engine torque is automatically reduced and/or the brake pressure is increased. In the event of excessive braking force, the engine torque is increased and/or the brake pressure is reduced. In the event of the rear wheel lifting off, the brake pressure on the front wheel is reduced. In all cases, the rear wheel may absorb more lateral guiding force.
3. Reducing the vehicle speed: This is achieved by increasing the brake pressure on the wheels or by reducing the engine torque.

According to one first specific embodiment of the present invention, the float angle or the change in the float angle is ascertained with the aid of a sensor system, which includes one or multiple of the following sensors: Sensors for detecting the longitudinal speed, a transverse acceleration sensor, a roll-rate sensor and a yaw-rate sensor, as well as optionally other sensors for a more accurate detection of the roll angle and/or pitch angle.

In a two-wheeled vehicle, the lateral speed v_{y} and thus the float angle depends on the roll speed, depending on the installation position of the sensors. The sensor system thus measures, in general, a float angle, which deviates from the slip angle of the rear wheel. In order to avoid this, it is proposed that the measuring signals be transformed to the contact point of the rear wheel with the roadway as a virtual measuring point. A measurement of the float angle at the contact point of the wheel with the roadway is largely independent of the inclination and the roll speed of the two-wheeled vehicle, so that the measuring result includes only the lateral drift of the rear wheel, if possible. The transformation is preferably performed with the aid of an algorithm, which converts the reference system to the contact point of the wheel. According to one preferred specific embodiment of the present invention, the transformed measured values, such as a transverse acceleration or a yaw rate, are included first in the calculation of the float angle or of the change in the float angle.

To determine float angle β or change in float angle dβ/dt, the following calculation may be performed, for example:

dv_{y}/dt=a_{y}ω_{z}·vₓ+ωₓ·v_{z}−g·sin φ·cos Θ (1)

where
dv_{y}/dt is the change in velocity in the transverse, i.e., y direction,
a_{y} is the measured transverse acceleration in the y direction,
ω_{z} is the yaw rate of the vehicle,
ωₓ is the roll rate,
vₓ is the longitudinal velocity of the vehicle,
v_{z} is the vertical velocity (all of the above variables in the vehicle reference system),
g is the acceleration of gravity,
φ is the inclination or roll angle, and
Θ is the pitch angle, for example, according to DIN70000.

The roll and pitch angles may be determined, for example, with the aid of yaw-rate sensors and acceleration sensors or with the aid of an inclination angle sensor. Since v_{z} is difficult to ascertain and is normally very small compared to v_{y}, v_{z}=0 m/s may be used as an approximation.

Velocity v_{y} in the transverse direction may be estimated by integration,

v_{y}=v_{y0}+∫dv_{y}/dt

where v_{y0} is a starting value. The float angle or slip angle is now obtained from v_{y} and inclination angle φ in the road reference system at the contact point of the wheel:

β=v_{y}/(vₓ·cos(φ) (2)

The change in float angle dβ/dt is the time derivative of float angle β.

According to one alternative specific embodiment, float angle β or change in float angle dβ/dt may also be measured with the aid of a radar sensor or an optical sensor.

The vehicle dynamics control system according to the present invention for two-wheeled vehicles preferably regulates, with the aid of at least one of the above-described measures, the float angle and/or the change in the float angle or the slip angle to a predefined setpoint value.

The steering torque resulting from a change in the braking torque on the front wheel is highly dependent on the inclination of the two-wheeled vehicle, on the vehicle geometry, and on the tires. According to one specific embodiment of the present invention, it is therefore proposed that the inclination of the two-wheeled vehicle be ascertained and the steering torque be varied as a function of the instantaneous inclination via the brake pressure on the front wheel brakes.

If the two-wheeled vehicle has a steering final controlling element and a steering torque is applied to the steering, the steering torque is preferably measured in such a way that it may be oversteered by the driver.

The control is preferably performed by a control unit, in which an appropriate regulating algorithm is stored.

### BRIEF DESCRIPTION OF THE DRAWING

FIG. 1 shows a schematic illustration of a motorcycle having a vehicle dynamics control system.

### DETAILED DESCRIPTION OF THE INVENTION

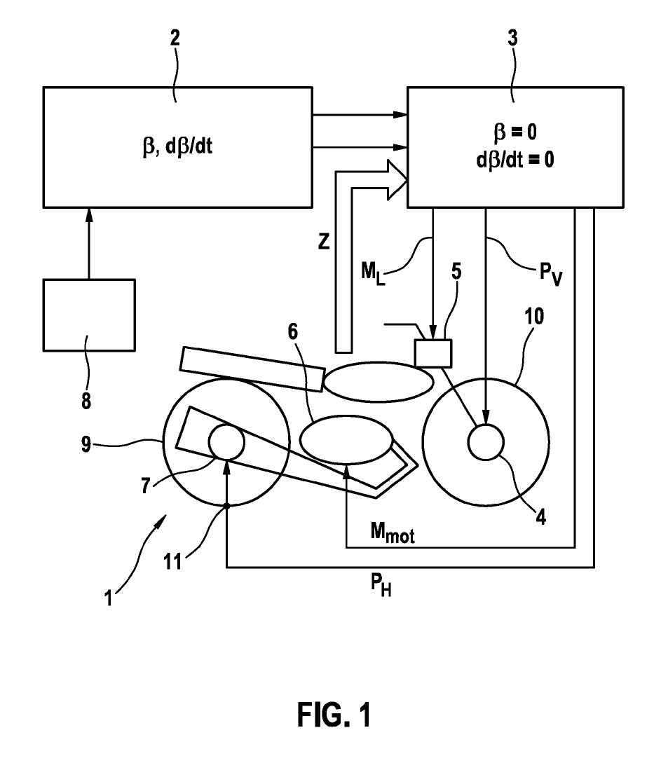

FIG. 1 shows a schematic illustration of a motorcycle 1, and different components of a vehicle dynamics control system for stabilizing motorcycle 1 in driving situations in which motorcycle 1 oversteers. The regulating system includes one or multiple sensors 2, 8, for determining the float angle and at least one final controlling element 4, 5, 6 and/or 7, which may be automatically controlled by a float angle controller 3. In a driving situation in which rear wheel 9 of motorcycle 1 slips laterally, float angle controller 3 intervenes in the driving operation with the aid of one or multiple final controlling elements 4 through 7.

The oversteering behavior of motorcycle 1 is recognized here with the aid of a transverse acceleration sensor, a yaw-rate sensor, and a roll and pitch sensor, which are combined in a block 8. However, radar, optical, or other sensors known from the related art may optionally also be used. A software algorithm, which is illustrated in block 2, ascertains a float angle β or a change in the float angle dβ/dt from the sensor signals. When float angle β or a change in the float angle dβ/dt exceeds a predefined threshold value, controller 3 becomes active and regulates the controlled variable to a setpoint value.

Front wheel brake 4, a steering final controlling element 5, the propulsion engine 6, or the rear wheel brake 7 may be controlled, for example, as final controlling elements of the control. Optionally multiple final controlling elements 4 through 7 may also be simultaneously controlled. Depending on the control deviation, controller 3 outputs an appropriate manipulated variable such as a front wheel brake pressure p_{V}, a rear wheel brake pressure p_{H}, an engine torque Mₘₒₜ, or a steering torque M_{L} to the particular final controlling element. If steering final controlling element 5 is controlled, steering torque M_{L} is preferably measured in such a way that it may be oversteered by the driver.

In the event of a control intervention on front wheel brake 4, the extent of the control intervention is preferably a function of the inclination of motorcycle 1, since the response of motorcycle 1 may vary substantially depending on the inclination. The inclination may be measured, for example, with the aid of a roll-rate sensor.

Controller 3 also constantly monitors the instantaneous driving state of the vehicle with the aid of a series of sensors, which deliver the corresponding driving state variables z.

If a full 6D inertial sensor system having three yaw-rate sensors and three acceleration sensors, and a GPS signal are available, the float angle may be determined even more accurately.

1-10. (canceled)

11. A method for stabilizing a two-wheeled vehicle in a driving situation in which an oversteering of the two-wheeled vehicle driven on a roadway is present, the method comprising:
ascertaining a variable describing the oversteering of the two-wheeled vehicle as a controlled variable; and
performing, by a controller, an automatic control stabilizing the two-wheeled vehicle in the case the controlled variable exceeds a predefined threshold value.

12. The method as recited in claim 11, wherein the variable describing the oversteering of the two-wheeled vehicle is one of (i) a float angle, (ii) a slip angle, (iii) a change over time of the float angle, or (iv) a change over time of the slip angle.

13. The method as recited in claim 12, wherein the control stabilizing the two-wheeled vehicle includes:
at least one of automatically (i) applying a steering torque to a steering mechanism of the two-wheeled vehicle, (ii) modifying a brake pressure acting on a front wheel brake, (iii) modifying a propulsion torque on a rear wheel, and (iv) modifying a brake pressure acting on a rear wheel brake.

14. The method as recited in claim 13, wherein the variable describing the oversteering of the two-wheeled vehicle is determined with the aid of at least one of a longitudinal velocity sensor, a transverse acceleration sensor, a yaw-rate sensor, a roll-rate sensor, a roll angle sensor, and a pitch angle sensor.

15. The method as recited in claim 14, wherein a measuring signal of the at least one sensor is transformed to a contact point of the rear wheel with the roadway as a virtual measuring point before one of the float angle or the change over time of the float angle is determined using the virtual measuring point.

16. The method as recited in claim 13, wherein at least one of the float angle and the change over time of the float angle is measured with the aid of one of a radar sensor or an optical sensor.

17. The method as recited in claim 16, wherein the controller regulates the at least one of the float angle and the change over time of the float angle to a predefined setpoint value.

18. The method as recited in claim 13, wherein an instantaneous inclination of the two-wheeled vehicle is ascertained and the brake pressure acting on the front wheel brake is modified as a function of the instantaneous inclination.

19. The method as recited in claim 13, wherein the control stabilizing the two-wheeled vehicle is automatically applying a steering torque to the steering mechanism of the two-wheeled vehicle.

20. A regulating device for stabilizing a two-wheeled vehicle in a driving situation in which an oversteering of the two-wheeled vehicle driven on a roadway is present, the device comprising:
a sensor system configured to ascertain a variable describing the oversteering of the two-wheeled vehicle as a controlled variable; and
a control system configured to automatically perform a control stabilizing the two-wheeled vehicle in the case the controlled variable exceeds a predefined threshold value, the control system including at least one of a wheel-brake control element, a steering control element and a propulsion control element.
